(19) United States
(12) Patent Application Publication
(10) Pub. No.: US 2026/0277819 A1
(43) Pub. Date: Sep. 17, 2026

(54) PREFETCH TO LAST LEVEL CACHE INTERCONNECT SEMANTIC

(71) Applicant: Intel Products IP LLC, Santa Clara, CA (US)

(72) Inventors: Ashwani KUMAR, Bangalore (IN); Trupti JOSHI, Bengaluru (IN); Eliel LOUZOUN, Jerusalem (IL)

(21) Appl. No.: 19/671,752

(22) Filed: May 8, 2026

(51) Int. Cl. G06F 12/0897; G06F 12/06; G06F 12/0862

(52) U.S. Cl. CPC G06F 12/0897; G06F 12/063; G06F 12/0862

(57) ABSTRACT

Methods and apparatus for prefetch to Last Level Cache (LLC) interconnect semantic. The method is implemented in a compute platform including a central processing unit (CPU) coupled to memory and including a plurality of cores, a shared LLC and an input-output (IO) block interconnected via a mesh interconnect. Entries are stored in a context association table including a primary address and one or more context addresses. Inbound transactions originating from the IO device coupled to the IO block are monitored and a corresponding inbound transaction address is compared with primary addresses in the context association table. When there is a match, data stored in memory at the one or more context addresses is prefetched from the memory and installed in the shared LLC. The shared LLC may comprise multiple LLC slices having associated Caching and Home agents (CHAs) co-located with cores at respective nodes in the mesh interconnect.

### BACKGROUND INFORMATION

Modern data centers utilize specialized Input/Output (I/O or IO) acceleration hardware like Infrastructure Processing Units (IPUs), SmartNICs, and other accelerators to offload tasks such as networking, storage, and security from the Central Processing Unit (CPU). These devices manage high-throughput, low-latency workloads—including RDMA (Remote Direct Memory Access), storage offloads (e.g., NVMe-oF (Non-volatile Memory Express over Fabric), iSCSI), packet processing, and distributed AI/ML (Artificial Intelligence/Machine Learning) inference—by accessing primary data buffers with predictable patterns. Typically, when an I/O device uses a data buffer, the CPU soon needs related context data, which often isn't cached, resulting in costly DRAM (Dynamic Random Access Memory) access (~100-300 ns). This latency can significantly impact performance in environments with tight microsecond latency budgets.

### BRIEF DESCRIPTION OF THE DRAWINGS

The foregoing aspects and many of the attendant advantages of this disclosure will become more readily appreciated as the same becomes better understood by reference to the following detailed description, when taken in conjunction with the accompanying drawings, wherein like reference numerals refer to like parts throughout the various views unless otherwise specified:

FIG. 1 is a diagram illustrating selected components for implementing the prefetch to Last Level Cache (LLC) interconnect semantic, according to one embodiment;

FIG. 2 is a diagram illustrating a context association table, according to one embodiment;

FIG. 3 is a flowchart illustrating operations performed by an address matching algorithm, according to one embodiment

FIG. 4 is a diagram of a prefetch request queue, according to one embodiment;

FIG. 5 is a diagram illustrating controls used by a rate limiter, according to one embodiment;

FIG. 6 is a flowchart illustrating operations and logic for performing a prefetch to LLC operation, according to one embodiment;

FIG. 7 is a schematic diagram illustrating selective components of a scalable processor architecture, according to one embodiment;

FIG. 8 is a diagram illustrating an HIOP block, according to one embodiment;

FIG. 9 is a schematic diagram illustrating datapaths used by a condensed RDMA receive example using the prefetch to LLC interconnect semantic, according to one embodiment; and

FIG. 10 is a flowchart illustrating operations performed by the condensed RDMA receive example of FIG. 9, according to one embodiment.

### DETAILED DESCRIPTION

Embodiments of methods and apparatus for prefetch to Last Level Cache (LLC) interconnect semantic are described herein. In the following description, numerous specific details are set forth to provide a thorough understanding of embodiments disclosed herein. One skilled in the relevant art will recognize, however, that the embodiments can be practiced without one or more of the specific details, or with other methods, components, materials, etc. In other instances, well-known structures, materials, or operations are not shown or described in detail to avoid obscuring aspects of the embodiments.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

In accordance with aspects of the embodiments disclosed herein, a Context Association Table integrated on an I/O block such as in a Peripheral Component Interconnect Express (PCIe) Root Port is provided that monitors I/O memory transactions, matches observed addresses against software-programmed associations, and generates “cache-only prefetch requests” for related context data addresses. A key architectural novelty is a new interconnect semantic—“Prefetch to LLC”—that fetches cache lines from memory and installs them in the LLC, enabling speculative prefetching from the I/O observe path.

In one aspect, the context association table integrates into a root port (such as a PCIe Root Port controller) at two insertion points. First, is as an observation point in an inbound transaction controller (ITC). In one embodiment, the observation point logic is located after transaction decode, before routing to the mesh fabric. The observation point logic observes inbound I/O-to-memory transactions (e.g., posted writes and non-posted reads), extracts the transaction address (e.g., a 52-bit physical address from a packet header). The monitoring is non-intrusive and is transparent to the primary transaction flow.

The second insertion point is at an injection point with a Cache/Pipeline Controller (CPC). Prefetch requests merge into the memory read arbitration path and are run at the lowest priority (yielding to demand CPU/I/O reads). The prefetch uses the existing MemRead path to the mesh fabric. The prefetch is rate-limited such that it consumes only spare bandwidth.

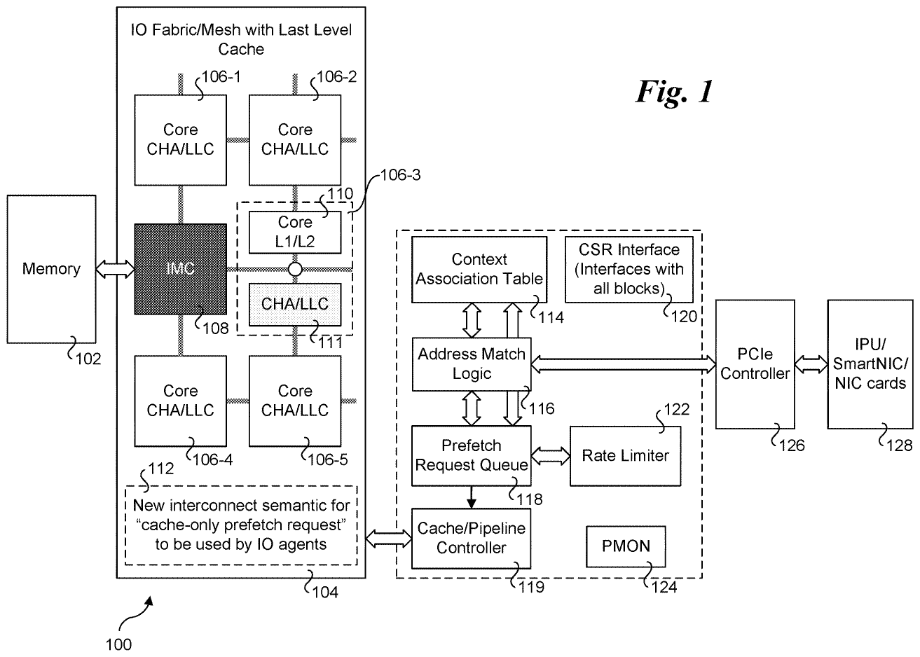

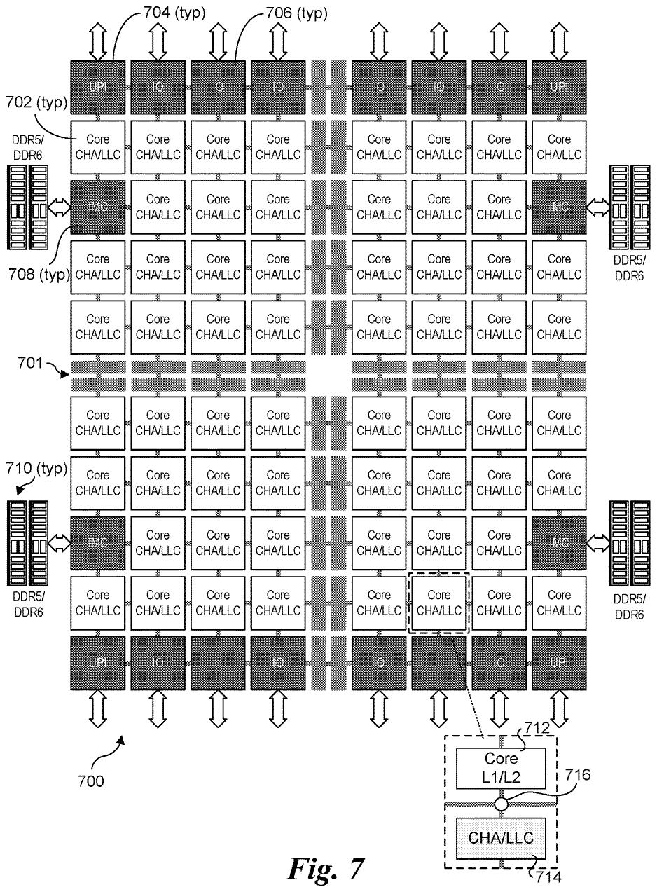

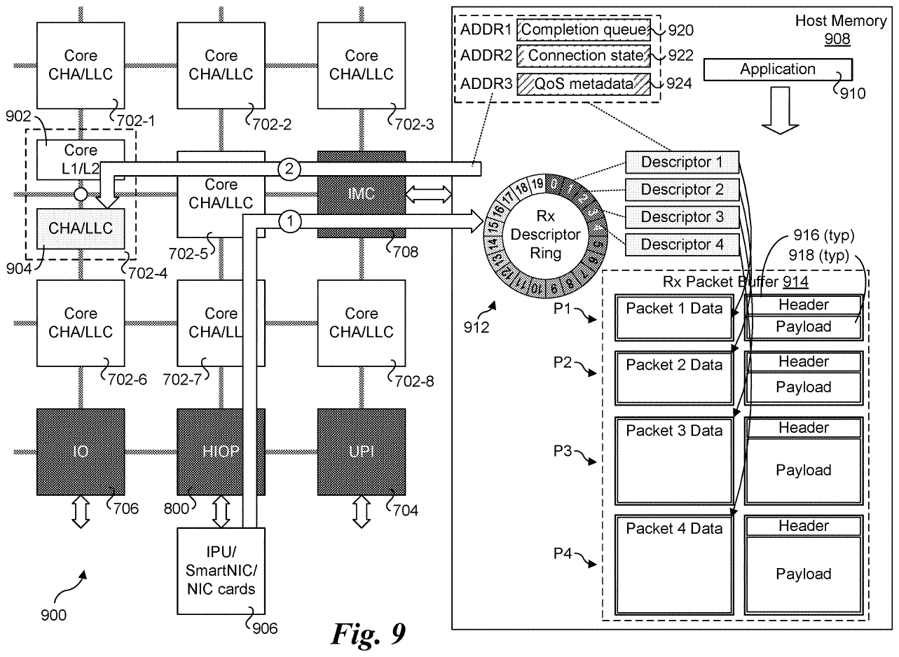

FIG. 1 shows a diagram 100 illustrating selected components implemented by some embodiments, where the components shown in the dashed boxes are new or modified. The existing components include memory 102, an IO (Input-Output) fabric/mesh with Last Level Cache 104, a PCIe controller 126, and an IPU (Infrastructure Processing Unit)/SmartNIC/NIC cards 128. In the illustrated embodiments IO fabric/mesh with Last Level Cache 104 is depicted with a core blocks 106-1, 106-2, 106-3, 106-4, and 106-5, each comprising a core 110 with a co-located caching and home agent (CHA) 111 having an LLC “slice” and, and an integrated memory controller (IMC) 108 that are interconnected a fabric/mesh. Further details of an IO fabric/mesh with Last Level Cache are discussed and shown below with reference to FIGS. 7 and 9.

The new components/blocks include a new interconnect semantic for “cache-only prefetch request” to be used by IO agents shown in dashed block 112, a context association table 114, and address match block 116, a prefetch request queue 118, a CSR (Configuration and Status Registers) interface 120, a rate limiter 122, and a Performance Monitor (PMON) 124. Cache/Pipeline Controller 119 is an existing component that has been modified.

### Context Association Table

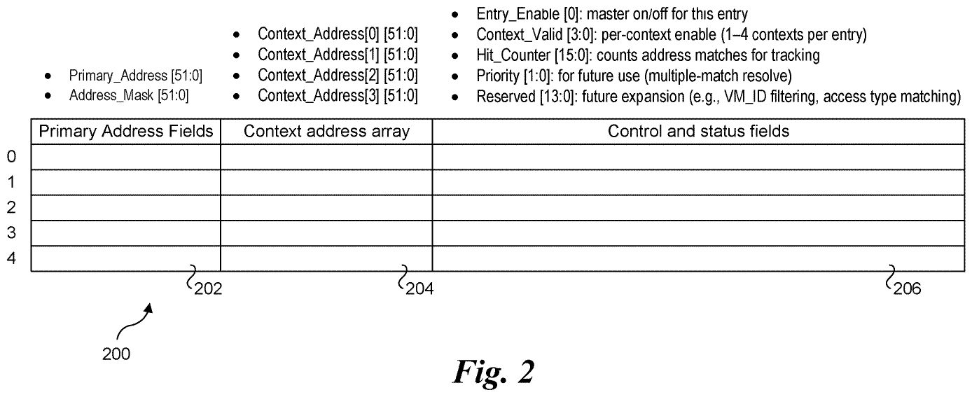

The Context association table, also referred to as the context table comprises a data structure that may be stored in a register or the like. FIG. 2 shows a context association table 200, according to one embodiment. In this example, there are five entries; however, this is merely exemplary and non-limiting, as the number of entries in a context association table may vary to meet various criteria.

Each entry includes primary address fields 202, a context address array 204, and control and status fields 206. The primary address fields include a primary address and an address mask. In the illustrated embodiment both the primary address and address mask comprise 52-bit fields for a total of 104 bits occupied by primary address field 202. Primary_Address [51:0] is the physical address to match. Address_Mask [51:0] is a mask enabling flexible matching granularity. For example, consider the following mask values.
Mask=0xFFFFF000 matches an entire 4KB page
Mask=0xFFC00000 matches an entire 4MB region
   Use of the address mask enables matching at different granularities such as cacheline, 4KB page, or larger regions, allowing one entry to cover a range of related addresses.

In one embodiment context address array 204 comprises four 52-bit context addresses for a total of 208 bits.
Context_Address[0] [51:0]
Context_Address[1] [51:0]
Context_Address[2] [51:0]
Context_Address [3] [51:0]

In one embodiment, control and status fields 206 comprise 100 bits. These include
Entry_Enable [0]: master on/off for this entry
Context_Valid [3:0]: per-context enable (1-4 contexts per entry)
Hit_Counter [15:0]: counts address matches for tracking
Priority [1:0]: for future use (multiple-match resolve)
Reserved [13:0]: future expansion (e.g., VM_ID filtering, access type matching)

In the illustrated embodiment context association table 200, there is a total of 412 bits per entry, and a total table storage of 5×412=2,060 bits=258 bytes

### Address Match Logic

The address match logic includes implementation of an address matching algorithm where, for each I/O-to-memory transaction observed in the inbound transaction controller (ITC), the logic determines whether the transaction address matches one of the programmable table entries, and if so, generates prefetches for the associated context addresses without impacting the original transaction.

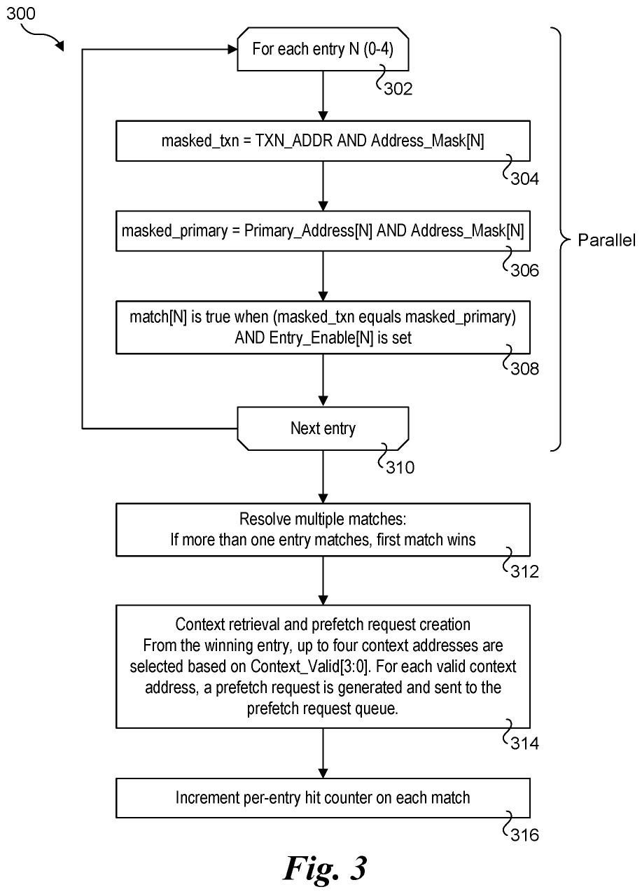

An embodiment of the address matching algorithm is illustrated as a flowchart 300 in FIG. 3. The process begins by performing a parallel masked compare across the entries context association table. As depicted by start and end loop blocks 302 and 310, the matching operations in blocks 304, 306, and 308 are performed for each entry in the context association table in parallel. In one embodiment the matching operations are implement in hardware and performed on every valid transaction. In one embodiment, all N compares occur in parallel using 52-bit comparators (one per entry).

In block 304, the masked transaction (masked_txn) is computed as the transaction address (TXN_ADDR) logically ANDed with the Address_Mask for the entry. In block 306 a masked_primary value is computed as the Primary_Address[N] ANDed with Address_Mask[N]. In block 308 the match outcome is determined where match[N] is true when (masked_txn equals masked_primary) and Entry_Enable[N] is set.

Following the match compare operations the logic proceeds to block 312 in which multiple matches are resolved for compare outcomes that identify multiple matches. In one embodiment, if more than one entry matches, the winning entry is selected using the rule: first match wins (Entry 0 has highest priority). In another embodiment a Priority field may be used for explicit ordering.

Next, in block 314 context retrieval and prefetch request creation is performed. From the winning entry, up to four context addresses are selected based on Context_Valid[3:0]. For each valid context address, a prefetch request is generated and sent to the prefetch request queue. In block 316 the per-entry hit counter is incremented on each match.

### Prefetch Request Generation and Queuing

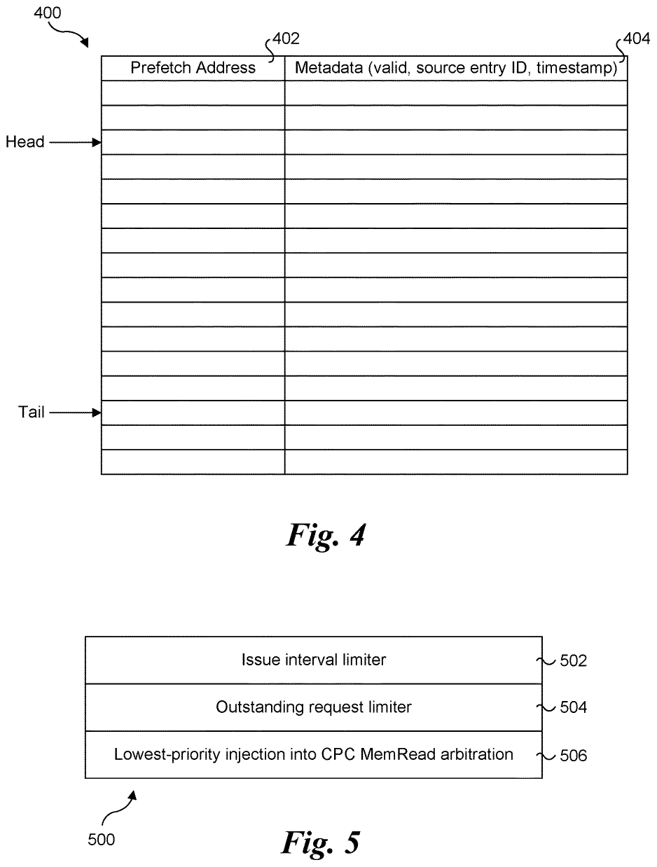

A single match may generate up to four prefetches, and I/O transactions can arrive back-to-back. Accordingly, in one embodiment a queue is used to decouple bursty match events from controlled prefetch issuance. An example of a prefetch request queue 400 is shown in FIG. 4. In this embodiment, prefetch request queue 400 is implemented as a circular First-In, First-Out (FIFO) buffer having a depth of 16 entries. In one embodiment, each FIFO entry includes a prefetch address field 402 and a metadata field 404. Examples of metadata include a valid flag, a source entry ID, and a timestamp.

For the enqueue side of prefetch request queue 400, on a match, each valid context address is enqueued (along with metadata in metadata field 404) at the current tail if space is available. If the queue is full, the request is dropped and an overflow counter is incremented. On the dequeue side, prefetches are issued from the head of the queue only when the rate limiter allows and when the cache/pipeline controller (CPC) path can accept them.

### Rate Limiting and Bandwidth Management

Unlimited prefetching can consume memory bandwidth and interfere with demand CPU and I/O traffic. Rate limiter 122 is used to address this. To address this, rate limiter 122 employs the controls shown in diagram 500 of FIG. 5.

Issue interval limiter 502 is a programmable cycle interval that spaces prefetch issuance. At most one prefetch is attempted per interval when the queue is not empty. Outstanding request limiter 504 is a programmable maximum value that limits the number of in-flight prefetches. New prefetches are not issued when the outstanding count reaches the configured limit.

For lowest-priority injection into CPC MemRead (Memory Read) arbitration 506, prefetch requests are injected into the CPC memory read path at the lowest priority, so they yield to demand CPU reads, demand I/O reads, and other higher-priority reads. This ensures prefetch uses only spare bandwidth.

An optional enhancement (not required for baseline) is adaptive throttling based on observed prefetch effectiveness using LLC-hit-based metrics; when hit rate is low, slow down; when high, speed up.

### Cache-Only Prefetch Semantic

A core requirement for the cache-only prefetch semantic implemented in block 112 of FIG. 1 is to fetch a cacheline from memory and install it into the LLC, but do not return completion data to the prefetch requester. The IPU/root port module does not consume the data. Avoiding completions saves bandwidth and avoids completion-buffer management.

Two exemplary implementation approaches are as follows. Under a first approach, reserved-bit encoding in existing MemRead is used. A reserved bit in the completion-queue ID field (CQID[10]) is set to indicate “no completion required.” The mesh routes the request normally; LLC/memory performs the fetch and installs the line; completion logic checks CQID[10] and drops completion when it is set.

Under a second approach, a new processor/core instruction set opcode for “prefetch to LLC with no completion” is added to the instruction set. This new interconnect opcode explicitly represents cache-only prefetch, installing in LLC without completion.

### Software Programming Interface

In one embodiment, a software programming interface is provided to update the data in the context association table. This feature is controlled via memory-mapped CSRs (Configuration and Status Registers) in the PCIe BAR (Base Address Register) space. In one embodiment approximately 75 registers are used.

In one embodiment, the software-configurable items include:
Global enable (master on/off)
Rate limiter configuration (issue interval, max outstanding)
Per-entry programming (5 entries):
Primary address (52-bit)
Address mask (52-bit)
Up to four context addresses (4×52-bit)
Context valid bits (enable 1-4 contexts)
Entry enable bit
Observability (for tuning and validation):
Total matches, total prefetches, queue overflow counter
Per-entry hit counters
Optional LLC-hit effectiveness counter as described

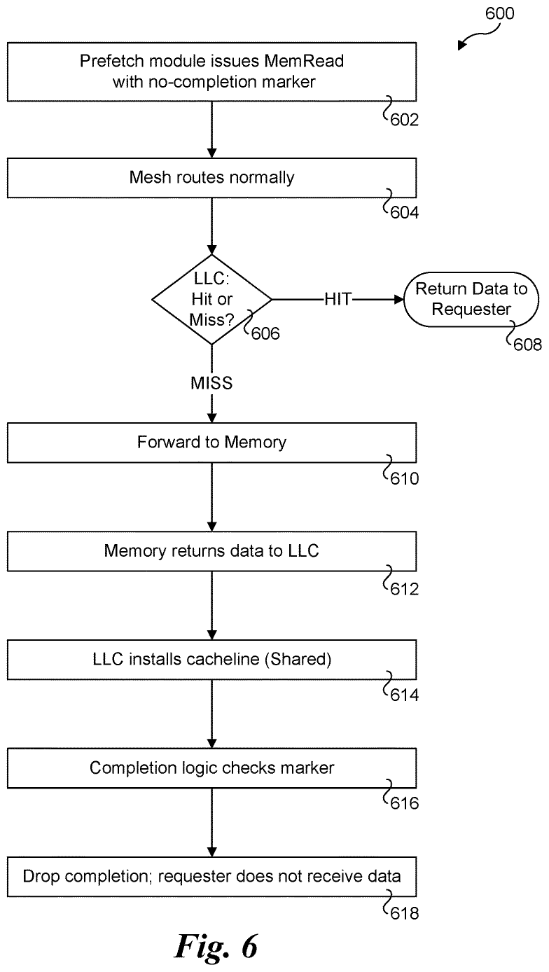

Flowchart 600 in FIG. 6 shows operations and logic implemented for performing prefetch to LLC operation, according to one embodiment. The process begins in block 602 where the prefetch module issues a MemRead with no completion marker. The MemRead is routed via the mesh/fabric in the conventional manner, as shown in block 604. In conjunction with the conventional MemRead, a check is made to whether the requested data is cached in an LLC. In a decision block 606 a determination is made to whether there is an LLC Hit or Miss. If the is a Hit, the data is returned to the requestor, as depicted in an end block 608.

In response to an LLC miss, the MemRead is forwarded via the mesh/fabric to memory, as shown in block 610. In block 612, the memory returns data in the form of a cacheline to the LLC, and the LLC installs (caches) the cacheline in block 614. In block 616 the completion logic checks the no completion marker. When marked (for no completion) the completion is dropped and the requester does not receive the requested data, as shown in block 618.

Selective components for scalable processor architecture 700 is shown in FIG. 7. Scalable processor architecture 700 implements a tile layout where various blocks are grouped onto tiles and placed in grid vertices. These grid vertices connect to a mesh interconnect, allowing blocks to be interconnected through a common mesh fabric/mesh 701. In this example, there are four tiles; however, the architecture is scalable such that the number of tiles and number of blocks in a tile may vary. The various blocks and tiles may be integrated on a System on a Chip (SoC) or System on Package (SoP) is some embodiments.

The blocks include Core CHA/LLC blocks 702, Universal Path Interconnect (UPI) blocks 704, IO blocks 706, and IMC blocks 708 connected to memory 710. As shown in the detail at the bottom right, each Core CHA/LLC block 702 includes a core subblock with local Lever 1 (L1) and Level 2 (L2) caches, that are co-located with a CHA and LLC slice 714. These subblocks access the fabric/mesh at nodes 716. Each core communicates with the uncore and LLC through the fabric/mesh.

Each CHA connects to the mesh and is the cache controller that handles all coherent memory requests in the uncore and maintains memory consistency across the system. Each CHA contains an LLC “slice.” Memory addresses are hashed across the available CHAs, so a request from a core or I/O device will be directed to the appropriate CHA unit based on the physical address. Note that this means there is no inherent affinity for a memory request from a core to go to its co-located CHA or LLC slice.

The IO blocks 706 include circuitry and components for interconnecting various types of IO devices to the fabric/mesh. Non-limiting examples of IO blocks include Mesh to I/O Scalable Fabric M2IOSF blocks and Host I/O Processor (HIOP) blocks. Generally, and IO block may be configured to facilitate connection with IO blocks employing different types of IO interconnect structures and protocols. In the examples describe and illustrated herein, the IO devices comprise PCIe devices.

In some embodiments, scalable processor architecture 700 implements Intel® Data Direct I/O Technology (DDIO), which enables I/O devices such as network interface controllers (NICs), disk controllers, and other peripherals to access the shared LLC directly without involving any core processing cycles and in a manner transparent to software.

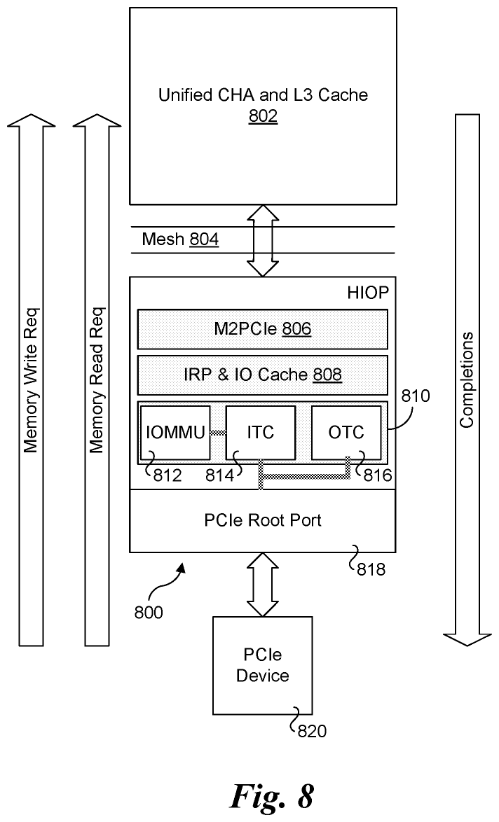

FIG. 8 shows the structure of an HIOP block 800 that is connected to a unified CHA and L3 cache 802 via an interconnect mesh 804. HIOP block 800 include a mesh to PCIe (M2PCIe) unit 806, an IIO (Integrated I/O) to Ring Port (IRP) unit 808, and an IIO unit 810 including an IO memory management unit (IOMMU) 812, an inbound transaction controller (ITC) 814 and an outbound transaction controller (OTC) 816. HIOP block 800 further includes a PCIe root port 818 that is connected to a PCIe device 820. As further illustrated, HIOP block 800 forwards memory write requests and memory read requests originating from PCIe device 820 to unified CHA and L3 cache 802, and forwards completions from unified CHA and L3 cache 802 to PCIe device 820.

Integrated I/O unit 810 employs the inbound and outbound traffic controllers for queueing requests; it is responsible for following PCI Express ordering rules and converting PCI Express requests to internal commands for IRP and vice-versa. In this context, “inbound” refers to I/O device-initiated requests sent to the CPU (also called upstream), while “outbound” refers to CPU-initiated requests sent to the I/O device (also called downstream).

IRP unit 808, sometimes called the cache tracker, is responsible for converting IIO requests (from PCIe/CXL or integrated accelerator agents) to mesh requests and vice versa. The IRP contains a local write cache that is used for accelerating inbound write requests. This cache should not be confused with processor L1, L2 caches, or the CHA LLC and can be thought of as a temporary write buffer. M2PCIe unit 806 bridges mesh 804 to IPR unit 808.

### Operational Example (Condensed RDMA Receive)

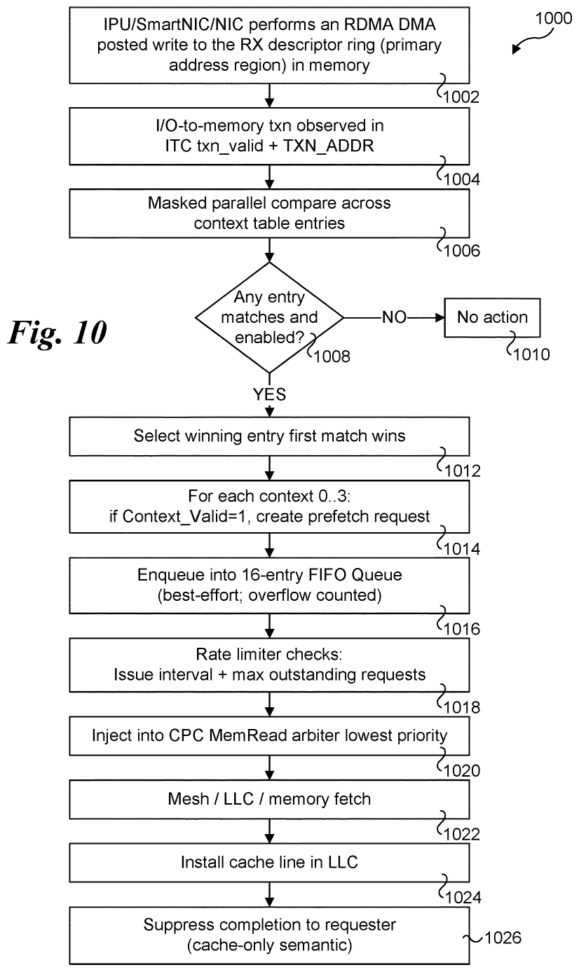

FIG. 10 shows a flowchart 1000 illustrating operations performed for implementing a prefetch to LLC for a condensed RDMA receive, while FIG. 9 shows a diagram 900 illustrating data flow paths corresponding to the example. Diagram 900 shows a portion of blocks in tile including Core CHA/LLC blocks 702-1, 702-2, 702-3, 702-4, 702-5, 702-6, 702-7, and 702-8, a UPI block 704, an IO block 706, an HOIP block 800, and an IMC 708. As depicted for Core CHA/LLC blocks 702-4, each of these blocks comprises a co-located core 902 with L1/L2 caches and a CHA with an LLC slice (CHA/LLC) 904. HIOP block 800 is connected to IPU/SmartNIC/NIC cards 906, which comprises one of an IPU, a SmartNIC, or a NIC PCIe card.

IMC 708 is connected to host memory 908, which depicts various components and data structures, including an application 910, an Rx descriptor ring 912, and an Rx packet buffer 914. Under various host architectures, application 910 may run on a platform operating system (OS), or may run on a guest OS or the like in a virtualized environment including one or more virtual machines (VMs) or containers.

Rx descriptor ring 912 is illustrative of multiple Rx descriptor rings. Generally, one or more Rx descriptor rings will be allocated by a host entity, such as a host operating system or IPU, SmartNIC, or NIC device driver. The terminology “descriptor ring” is used herein to represent a data structure in memory having multiple slots or entries in which respective descriptors are temporarily buffered. These data structures may also be called ring buffers or circular buffers, or the like. A descriptor ring, ring buffer, or circular buffer may have fixed-size slots or entries or may have may employ a wrap-around linked-list with variable size entries. Each Rx descriptor ring includes a plurality of Rx descriptors. For example, Rx descriptor ring 912 includes n descriptors, with each descriptor buffered in a respective slot in the ring. In one non-limiting example, n=128, noting the number of slots for a ring may vary depending on the needs for an implementation and/or other criteria. In some implementations, a set of one or more Rx descriptor rings may be implemented for an associated entity and/or component. For example, for a NIC that includes multiple protocol engines (PEs), a set of one or more Rx descriptor rings may be provided for each PE. Under another approach, a set of Rx descriptor rings may be allocated for each of multiple VMs or containers on the host.

In the simplified example shown in FIG. 9, there are four Rx descriptors 1, 2, 3, and 4 corresponding to respective packets P1, P2, P3, and P4. As is known in the art, Rx descriptors contain information that is used by software such as application 910 running on a host to facilitate packet processing operation for packets that are buffered in Rx packet buffers on the host. For example, Rx packet buffer 914 is shown having packet data for packets P1, P2, P3, and P4, with the packet data for each packet having a header 916 and payload 918. Among other data, the descriptors contain information that identifies where the packet associated with a descriptor is buffered in host memory 908. As further shown, Descriptor 1 includes completion queue 920, connection state 922, and QoS metadata 924 having respective addresses ADDR1, ADDR2, and ADDR3.

With reference to flowchart 1000 the prefetch to LLC for a condensed RDMA receive process starts in block 1002 with the RDMA entity (e.g., IPU/SmartNIC/NIC cards 906) performs an RDMA DMA posted write with an associated transaction address to the Rx descriptor ring 912 in host memory 908. As shown datapath ‘1’ in FIG. 9, the RDMA DMA posted write originates from IPU/SmartNIC/NIC cards 906 and is forwarded from HIOP block 800 via the fabric/mesh to host IMC 708, which writes data associated with Descriptor 1 to slot 1 in Rx descriptor ring 912 at the transaction address.

In connection with the forwarding operation, in blocks 1004 and 1006 the ITC in HOIP 800 observes the transaction address after decode and performs a masked match against the programmable table entries in the context table. In block 1008 the I/O-to-memory transaction corresponding to the RDMA DMA posted write is observed by the ITC in txn_valid+TXN_ADDR. The masked parallel compare operation across the context table entries is performed in block 1006.

In a decision block 1008 a determination is made to whether there are any entry matches that are also enabled. If the answer is NO, no action is taken, as shown in block 1010. If the answer is YES, the logic proceeds to block 1012 in which a winning entry is selected. In accordance with a default scheme described above, the first matching entry that is enabled wins.

As shown in block 1014, for each context 0 . . . 3, if the Context_Valid=1, a prefetch request is created. In block 1016, the prefetch request(s) is/are enqueued into the 16-entry FIFO queue using best-effort. For this example, prefetches for the associated context addresses ADDR1, ADDR2, and ADDR3 of completion queue 920, connection state 922, and QoS metadata 924 are enqueued. If a FIFO entry is not available, the overflow counter is incremented.

Rate limiter checks are then performed in block 1018, including the issue interval and maximum outstanding request checks.

Prefetches are issued later under rate limiting and injected into CPC MemRead path at lowest priority, as shown in block 1020. For each prefetch, a cache line of data at the context address associated with the enqueued prefetch entry is read from (host) memory, and the cache is installed in the LLC, as shown in blocks 1022 and 1024. As shown in block 1026, the completion that would normally be returned to the requester is suppressed (cache-only semantic).

The CPC MemRead path used by the prefetch may be the same as datapath ‘1’ or may be along the different datapath to IMC 708 depending on the traffic along interconnect segments in the fabric/mesh. Datapath ‘2’ shows an example of the datapath from the cacheline read from host memory 908 to CHA/LLC 904, the LLC slice in which the cache line is installed. Subsequently, when an IPU/SmartNIC/NIC interrupt arrives the CPU ISR reads of the context structures at the prefetched addresses result in LLC hits rather than LLC misses.

### Performance Comparison

Without the context prefetch disclosed herein, the ISR time is dominated by multiple LLC misses (DRAM penalties), requiring the content data to be read from memory. With the context prefetch, the ISR reads hit in LLC, reducing ISR latency substantially. For example, during experimental testing, average ISR latency was reduced from 660 ns down to 80 ns, an 88% reduction.

### Further Enhancements

As mentioned above, there is no inherent affinity for a memory request from a core to go to its co-located CHA or LLC slice. Thus, under the foregoing embodiment, the prefetch MemRead goes to the CHA determined by physical address interleaving (standard mesh hash). There is no LLC slice selection—it lands wherever the address maps to. The amount of extra latency for LLC hits will be a function of the datapath length from the core issuing the memory request and the LLC holding the cacheline for the memory request. Under a further enhancement, this latency can be further reduced.

For an Rx descriptor ring, the NIC driver binds each Rx queue to a specific CPU core at setup time (via IRQ affinity, DPDK (Data Plane Data Kit) queue setup, etc.). The core that calls into the driver to program the Context Association Table entry is the core that will later run the ISR for that queue. These are issued from the same core.

Every MMIO write on the mesh carries a CRNID (Creator Node ID) in the IDI transaction header—the mesh node ID of the CPU that issued the write. This is confirmed in the HIOP block. This CRNID maps directly to the LLC slice co-located with that core.

When the HIOP block hardware receives an MMIO write that programs a context table entry, it captures the CRNID from the incoming IDI transaction header and stores it as a new field in the context table entry. When the prefetch MemRead is later generated by the CPC, it includes this stored CRNID as the preferred home node hint, routing the prefetch to the LLC slice co-located with the processing core.

The Context Association Table entry format change is:
Current: {valid|trigger_addr|context_base_addr}
Enhanced: {valid|trigger_addr|context_base_addr|preferred_cha_id}
   The enhancement results in approximately 7 additional bits per entry.

While various embodiments described herein use the term System-on-a-Chip or System-on-Chip (“SoC”) to describe a device or system having a processor and associated circuitry (e.g., Input/Output (“I/O”) circuitry, power delivery circuitry, memory circuitry, etc.) integrated monolithically into a single Integrated Circuit (“IC”) die, or chip, the present disclosure is not limited in that respect. For example, in various embodiments of the present disclosure, a device or system can have one or more processors (e.g., one or more processor cores) and associated circuitry (e.g., Input/Output (“I/O”) circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems the various dies, tiles and/or chiplets can be physically and electrically coupled together by a package structure including, for example, various packaging substrates, interposers, active interposers, photonic interposers, interconnect bridges and the like. The disaggregated collection of discrete dies, tiles, and/or chiplets can also be part of a System-on-Package (“SoP”).

The following examples pertain to additional examples of the teachings and principles disclosed herein.
Example 1. A method implemented in a compute platform including a central processing unit (CPU) coupled to memory and including a plurality of cores, a shared last level cache (LLC), and an input-output (IO) block interconnected via a mesh interconnect. Entries are stored in a context association table including a primary address and one or more context addresses. Inbound transactions originating from an IO device coupled to the IO block are monitored and an inbound transaction address for an inbound transaction are compared with the primary addresses in the context association table to identify one or more matching entries. When there is a match, data stored in memory at the one or more context addresses in a matching entry is prefetched and installing the prefetched data in the shared LLC.
Example 2. The method of example 1, wherein the inbound transaction is a posted write request, further comprising not returning a completion for the inbound transaction to the IO device.
Example 3. The method of example 1 or 2, wherein the address for the inbound transaction is compared with multiple primary addresses in parallel.
Example 4. The method of any of the preceding examples, further comprising programming the context association table entries with software executing on the CPU.
Example 5. The method of any of the preceding examples, wherein the shared LLC comprises a plurality of LLC slices co-located with respective cores at each of a plurality of mesh nodes in the mesh interconnect, and wherein installing the data in the shared LLC comprises installing the data in one of the LLC slices.
Example 6. The method of example 5, further comprising storing, for a content association table entry, a node identifier and routing the prefetched data to be installed in an LLC slice co-located at the mesh node identified by the node identifier.
Example 7. The method of example 6, further comprising capturing a node identifier in a memory mapped IO (MMIO) transaction issued by a core to program a context association table entry and adding the node identifier to the context association table entry.
Example 8. The method of any of the preceding examples, further comprising detecting there are multiple entries in the context association table with primary addresses that match the inbound transaction address and identifying a winning context association table entry.
Example 9. The method of any of the preceding examples, further comprising enqueuing a plurality of prefetch requests in a prefetch request queue in the IO block, each prefetch request identifying an associated context address and dequeuing prefetch requests from the prefetch request queue.
Example 10. The method of example 9, further comprising employing a rate limiter to limit a rate at which prefetched requests are dequeued from the prefetch request queue.
Example 11. A System on a chip (SoC) or System on Package (SoP) comprising an interconnect mesh having a plurality of mesh nodes, a plurality of processor cores located as respective mesh nodes, a plurality of last level cache (LLC) slices respectively co-located with a respective processor core, an input-output (IO) block coupled to a mesh nodes having an IO interface configured to be coupled to an IO device, and an integrated memory controller (IMC) block coupled to a mesh node and configured to control access to memory stored in one of more memory devices configured to be connected to the IMC block. The SoC or SoP is configured to store entries in a context association table including a primary address and one or more context addresses, monitor inbound transactions originating from the IO device, compare an inbound transaction address for an inbound transaction with the primary addresses in the context association table to identify a matching entry. When there is a match, prefetch data stored in memory at the one or more context addresses for the matching entry and install the prefetched data in one of the LLC slices.
Example 12. The SoC or SoP of example 11, wherein the inbound transaction is a posted write request, further comprising not returning a completion for the inbound transaction to the IO device.
Example 13. The SoC or SoP of example 11 or 12, wherein the address for the inbound transaction is compared with multiple primary addresses in the context association table entries in parallel.
Example 14. The SoC or SoP of example 13, wherein the IO block includes the context association table, address match logic to match the address for the inbound transaction with primary addresses for multiple context association table entries in parallel, and a prefetch request queue to queue prefetch requests, each prefetch request identifying an associated context address.
Example 15. The SoC or SoP of example 14, further comprising a rate limiter to limit a rate at which prefetched requests are dequeued from the prefetch request queue and forwarded to the mesh interconnect to prefetch the data from memory.
Example 16. An apparatus, comprising an input-output (IO) block having integrated circuitry including a mesh to peripheral component interconnect express (PCIe) unit to be coupled to a mesh interconnect having a plurality of mesh nodes to which a plurality of blocks are coupled, including processor core blocks, last level cache (LLC) blocks, and a memory controller block configured to be coupled to memory, a peripheral component interconnect express (PCIe) root port configured to interface with a PCIe IO device, and an inbound transaction controller. The apparatus further includes a context association table, configured to store a plurality of entries comprising a primary address and one or more context addresses, circuitry and logic to monitor inbound transactions originating from the PCIe device and extract inbound transaction addresses, address match logic to match an address extracted from an inbound transaction with primary addresses of entries in the context association table, and circuitry and logic to detect when there is an address match from the address match logic and issue a prefetch data request configured to be forwarded via the mesh interconnect to retrieve data stored at the one or more context addresses in entry in the context association table having the matching primary address and install the data in one of the LLC blocks.
Example 17. The apparatus of example 16, further comprising a prefetch request queue configured to enqueuing a plurality of prefetch requests, each prefetch request identifying an associated context address.
Example 18. The apparatus of example 17, further comprising logic to dequeue a prefetch request from the prefetch request queue and issue prefetch data request having the context address associated with the prefetch request.
Example 19. The apparatus of example 18, further comprises a rate limiter to limit a rate at which prefetched requests are dequeued from the prefetch request queue.
Example 20. The apparatus of any of examples 16-19, further comprising an Integrated IO (IIO) to Ring Port (IRP) unit configured to convert IIO requests including inbound transactions to mesh requests.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Italicized letters, such as ‘n’, etc. in the foregoing detailed description are used to depict an integer number, and the use of a particular letter is not limited to particular embodiments. Moreover, the same letter may be used in separate claims to represent separate integer numbers, or different letters may be used. In addition, use of a particular letter in the detailed description may or may not match the letter used in a claim that pertains to the same subject matter in the detailed description.

As discussed above, various aspects of the embodiments herein may be facilitated by corresponding software and/or firmware components and applications, such as software and/or firmware executed by an embedded processor or the like. Thus, embodiments may be used as or to support a software program, software modules, firmware, and/or distributed software executed upon some form of processor, processing core, or embedded logic, or a virtual machine running on a processor or core or otherwise implemented or realized upon or within a non-transitory computer-readable or machine-readable storage medium. A non-transitory computer-readable or machine-readable storage medium includes any mechanism for storing or transmitting information in a form readable by a machine (e.g., a computer). For example, a non-transitory computer-readable or machine-readable storage medium includes any mechanism that provides (i.e., stores and/or transmits) information in a form accessible by a computer or computing machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A non-transitory computer-readable or machine-readable storage medium may also include a storage or database from which content can be downloaded. The non-transitory computer-readable or machine-readable storage medium may also include a device or product having content stored thereon at a time of sale or delivery. Thus, delivering a device with stored content, or offering content for download over a communication medium may be understood as providing an article of manufacture comprising a non-transitory computer-readable or machine-readable storage medium with such content described herein.

Various components referred to above as processes, servers, or tools described herein may be a means for performing the functions described. The operations and functions performed by various components described herein may be implemented by software running on a processing element, via embedded hardware or the like, or any combination of hardware and software. Such components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration information, etc.) may be provided via an article of manufacture including non-transitory computer-readable or machine-readable storage medium, which provides content that represents instructions that can be executed. The content may result in a computer performing various functions/operations described herein.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments, including what is described in the Abstract, is not intended to be exhaustive or to limit the embodiments to the precise forms disclosed. While specific embodiments of, and examples for, the teachings and principles are described herein for illustrative purposes, various equivalent modifications are possible within the scope of the claims, as those skilled in the relevant art will recognize.

These modifications can be made to the embodiments in light of the above detailed description. The terms used in the following claims should not be construed to limit the claim scope to the specific embodiments disclosed in the specification and the drawings. Rather, the scope of the claims is to be determined entirely by the following claims, which are to be construed in accordance with established doctrines of claim interpretation.

What is claimed is:

1. A method implemented in a compute platform including a central processing unit (CPU) coupled to memory and including a plurality of cores, a shared last level cache (LLC), and an input-output (IO) block interconnected via a mesh interconnect, comprising:
storing entries in a context association table including a primary address and one or more context addresses;
monitoring inbound transactions originating from an IO device coupled to the IO block;
comparing an inbound transaction address for an inbound transaction with the primary addresses in the context association table to identify one or more matching entries; and
when there is a match, prefetching data stored in memory at the one or more context addresses in a matching entry and installing the prefetched data in the shared LLC.

2. The method of claim 1, wherein the inbound transaction is a posted write request, further comprising not returning a completion for the inbound transaction to the IO device.

3. The method of claim 1, wherein the address for the inbound transaction is compared with multiple primary addresses in parallel.

4. The method of claim 1, further comprising programming the context association table entries with software executing on the CPU.

5. The method of claim 1, wherein the shared LLC comprises a plurality of LLC slices co-located with respective cores at each of a plurality of mesh nodes in the mesh interconnect, and wherein installing the data in the shared LLC comprises installing the data in one of the LLC slices.

6. The method of claim 5, further comprising:
storing, for a content association table entry, a node identifier; and
routing the prefetched data to be installed in an LLC slice co-located at the mesh node identified by the node identifier.

7. The method of claim 6, further comprising capturing a node identifier in a memory mapped IO (MMIO) transaction issued by a core to program a context association table entry and adding the node identifier to the context association table entry.

8. The method of claim 1, further comprising:
detecting there are multiple entries in the context association table with primary addresses that match the inbound transaction address; and
identifying a winning context association table entry.

9. The method of claim 1, further comprising:
enqueuing a plurality of prefetch requests in a prefetch request queue in the IO block, each prefetch request identifying an associated context address; and
dequeuing prefetch requests from the prefetch request queue.

10. The method of claim 9, further comprising employing a rate limiter to limit a rate at which prefetched requests are dequeued from the prefetch request queue.

11. A System on a chip (SoC) or System on Package (SoP) comprising:
an interconnect mesh having a plurality of mesh nodes;
a plurality of processor cores located as respective mesh nodes;
a plurality of last level cache (LLC) slices respectively co-located with a respective processor core;
an input-output (IO) block coupled to a mesh nodes having an IO interface configured to be coupled to an IO device; and
an integrated memory controller (IMC) block coupled to a mesh node and configured to control access to memory stored in one of more memory devices configured to be connected to the IMC block;
wherein the SoC or SoP is configured to,
store entries in a context association table including a primary address and one or more context addresses;
monitor inbound transactions originating from the IO device;
compare an inbound transaction address for an inbound transaction with the primary addresses in the context association table to identify a matching entry; and
when there is a match, prefetch data stored in memory at the one or more context addresses for the matching entry and install the prefetched data in one of the LLC slices.

12. The SoC or SoP of claim 11, wherein the inbound transaction is a posted write request, further comprising not returning a completion for the inbound transaction to the IO device.

13. The SoC or SoP of claim 11, wherein the address for the inbound transaction is compared with multiple primary addresses in the context association table entries in parallel.

14. The SoC or SoP of claim 13, wherein the IO block includes:
the context association table;
address match logic to match the address for the inbound transaction with primary addresses for multiple context association table entries in parallel; and
a prefetch request queue to queue prefetch requests, each prefetch request identifying an associated context address.

15. The SoC or SoP of claim 14, further comprising a rate limiter to limit a rate at which prefetched requests are dequeued from the prefetch request queue and forwarded to the mesh interconnect to prefetch the data from memory.

16. An apparatus, comprising an input-output (IO) block having integrated circuitry including,
a mesh to peripheral component interconnect express (PCIe) unit to be coupled to a mesh interconnect having a plurality of mesh nodes to which a plurality of blocks are coupled, including processor core blocks, last level cache (LLC) blocks, and a memory controller block configured to be coupled to memory;
a peripheral component interconnect express (PCIe) root port configured to interface with a PCIe IO device;
an inbound transaction controller;
a context association table, configured to store a plurality of entries comprising a primary address and one or more context addresses;
circuitry and logic to monitor inbound transactions originating from the PCIe device and extract inbound transaction addresses;
address match logic to match an address extracted from an inbound transaction with primary addresses of entries in the context association table; and
circuitry and logic to detect when there is an address match from the address match logic and issue a prefetch data request configured to be forwarded via the mesh interconnect to retrieve data stored at the one or more context addresses in entry in the context association table having the matching primary address and install the data in one of the LLC blocks.

17. The apparatus of claim 16, further comprising a prefetch request queue configured to enqueuing a plurality of prefetch requests, each prefetch request identifying an associated context address.

18. The apparatus of claim 17, further comprising logic to dequeue a prefetch request from the prefetch request queue and issue prefetch data request having the context address associated with the prefetch request.

19. The apparatus of claim 18, further comprises a rate limiter to limit a rate at which prefetched requests are dequeued from the prefetch request queue.

20. The apparatus of claim 16, further comprising an Integrated IO (IIO) to Ring Port (IRP) unit configured to convert IIO requests including inbound transactions to mesh requests.
